(19) United States
(12) Patent Application Publication
(10) Pub. No.: US 2025/0191535 A1
(43) Pub. Date: Jun. 12, 2025

(54) DISPLAY DEVICE AND METHOD OF DRIVING SAME

(71) Applicant: LG Display Co., Ltd., Seoul (KR)

(72) Inventors: Moo Kyoung HONG, Paju-si (KR); Dong Kyu YANG, Paju-si (KR); Sin Kyun PARK, Paju-si (KR)

(73) Assignee: LG Display Co., Ltd., Seoul (KR)

(21) Appl. No.: 18/917,676

(22) Filed: Oct. 16, 2024

(30) Foreign Application Priority Data
Dec. 6, 2023 (KR) 10-2023-0175400

(51) Int. Cl. G09G 3/3233; G09G 3/00

(52) U.S. Cl. CPC G09G 3/3233; G09G 3/006; G09G 2300/0413; G09G 2300/0842; G09G 2310/08; G09G 2320/0233; G09G 2320/0261; G09G 2320/045; G09G 2330/04; G09G 2330/12

(57) ABSTRACT

A display device can include a display panel including subpixels disposed in a display area and dummy subpixels disposed in an outer area of the display panel, a driving circuit configured to output a sensing data voltage for sensing a first subpixel among the subpixels and a first dummy subpixel among the dummy subpixels, and a sensing circuit configured to receive a first sensing value from a sensing node of the first subpixel and a second sensing value from a sensing node of the first dummy subpixel, and generate a sensing voltage based on a sum of the first sensing value and the second sensing value.

### CROSS-REFERENCE TO RELATED APPLICATION

This application claims priority to Korean Patent Application No. 10-2023-0175400, filed in the Republic of Korea, on Dec. 6, 2023, the entirety of which is hereby incorporated by reference into the present application as if fully set forth herein.

### BACKGROUND

### Field

The present disclosure relates to a display device and a method of driving the same.

### Discussion of the Related Art

As information technology develops, the market for display devices, which are communication media between users and information, is growing. Accordingly, display devices such as a light emitting display (LED) device, a quantum dot display (QDD) device, and a liquid crystal display (LCD) device are increasingly used.

The display devices described above include a display panel including subpixels, a driver outputting driving signals for driving the display panel, and a power supply for generating power to be supplied to the display panel or the driver.

In such display devices, when driving signals, for example, a scan signal and a data signal, are supplied to subpixels formed in a display panel, selected subpixels transmit light or directly emit light, thereby displaying an image.

However, as the resolution and driving frequency of display devices increase, there may not be enough time to perform a subpixel sensing operation for performing compensation. Thus, a need exists for a display device that can reduce the time it takes to perform sensing of the subpixels even at high driving frequencies or high resolutions.

### SUMMARY OF THE DISCLOSURE

Accordingly, the present disclosure is directed to a display device and a method of driving the same that substantially obviate one or more problems due to limitations and disadvantages of the related art.

An object of the present disclosure is to reduce a time required to acquire a sensing voltage such that deterioration of elements included in a display panel can be sensed and compensated for even in high-resolution, high-frequency, and high-pixel per inch (hereinafter referred to as PPI) models and to secure enough time for precise compensation based on minimization of a sensing time to improve compensation performance.

Additional advantages, objects, and features of the present disclosure will be set forth in part in the description which follows and in part will become apparent to those having ordinary skill in the art upon examination of the following or can be learned from practice of the present disclosure. The objectives and other advantages of the present disclosure can be realized and attained by the structure particularly pointed out in the written description and claims hereof as well as the appended drawings.

To achieve these objects and other advantages and in accordance with the purpose of the present disclosure, as embodied and broadly described herein, a display device includes a display panel including subpixels disposed in a display area and dummy subpixels disposed in an outer area, a driving circuit configured to output a sensing data voltage for sensing a first subpixel among the subpixels and a first dummy subpixel among the dummy subpixels, and a sensing circuit configured to acquire, as a sensing voltage, a third sensing value obtained by adding a first sensing value applied to a sensing node of the first subpixel to a second sensing value applied to the first dummy subpixel.

The second sensing value applied to the first dummy subpixel can act as a constant current source for increasing current at the time of sensing the first sensing value applied to the sensing node of the first subpixel.

The display device can include a compensator configured to generate a compensation value for compensating the subpixel based on the first sensing value excluding the second sensing value from the sensing voltage.

The sensing circuit can acquire a sensing value from one of the dummy subpixels or acquire sensing values from a plurality of dummy subpixels in response to at least one of the resolution, frequency, or PPI of the display panel.

The dummy subpixels can display a black image when a position where a protection image displayed based on the subpixels is displayed is moved.

In another aspect of the present disclosure, a display device includes a display panel including subpixels disposed in a display area and dummy subpixels disposed in an outer area, a driving circuit configured to display a protection image based on the subpixels, to move a position where the protection image is displayed, and to move a position of a black image displayed on at least one of the dummy subpixels whenever the display position of the protection image is moved, and a sensing circuit configured to acquire a first sensing value from a first subpixel among the subpixels and a second sensing value from a first dummy subpixel displaying a black image among the dummy subpixels, and to acquire a third sensing value obtained by adding the first sensing value to the second sensing value as a sensing voltage.

The display device can include a compensator configured to generate a compensation value for compensating the subpixel based on the first sensing value excluding the second sensing value from the sensing voltage.

The sensing circuit can acquire a sensing value from one of the dummy subpixels or acquire sensing values from a plurality of dummy subpixels in response to at least one of the resolution, frequency, or PPI of the display panel.

In another aspect of the present disclosure, a method of driving a display device includes displaying a protection image based on subpixels disposed in a display area of a display panel and moving a position where the protection image is displayed, displaying a black image on at least one of dummy subpixels disposed in an outer area of the display panel and moving a position of the black image whenever the display position of the protection image is moved, acquiring a first sensing value from a first subpixel among the subpixels and a second sensing value from a first dummy subpixel displaying the black image among the dummy subpixels, acquiring a third sensing value obtained by adding the first sensing value to the second sensing value as a sensing voltage, and generating a compensation value for compensating for at least one of the subpixels based on the first sensing value excluding the second sensing value from the sensing voltage.

The acquiring of the sensing voltage can include acquiring a sensing value from one of the dummy subpixels or acquiring sensing values from a plurality of dummy subpixels in response to at least one of the resolution, frequency, or PPI of the display panel.

It is to be understood that both the foregoing general description and the following detailed description of the present disclosure are examples and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram schematically showing a light emitting display device according to an embodiment of the present disclosure, FIG. 2 is a configuration diagram schematically showing a subpixel shown in FIG. 1 according to an embodiment of the present disclosure, and FIG. 3 is a diagram illustrating a pixel composed of subpixels according to an embodiment of the present disclosure;

FIG. 4 and FIG. 5 are diagrams illustrating the configuration of a gate-in-panel type gate driver according to embodiments of the present disclosure, and FIG. 6 is a diagram showing an example of the arrangement of the gate-in-panel type gate driver according to an embodiment of the present disclosure;

FIG. 7 is a diagram schematically showing a subpixel and a data driver according to an embodiment of the present disclosure, FIG. 8 is a diagram schematically showing a subpixel and a data driver according to an embodiment of the present disclosure, and FIG. 9 is a waveform diagram illustrating a sensing period and a display period according to an embodiment of the present disclosure;

FIG. 10 is a diagram showing some of components included in the data driver according to an embodiment of the present disclosure in more detail, and FIG. 11 and FIG. 12 are diagrams showing a method of sensing a display panel according to embodiments of the present disclosure;

FIG. 13 is a diagram showing dummy pixel groups included in a display panel of a light emitting display device according to an embodiment of the present disclosure, and FIG. 14 to FIG. 16 are diagrams illustrating an orbit driving method of the display panel according to embodiments of the present disclosure;

FIG. 17 is a diagram showing the position of a sensing target subpixel of the display panel according to an embodiment of the present disclosure, FIG. 18 is an equivalent circuit diagram of a C-th dummy subpixel and a K-th subpixel shown in FIG. 17 according to an embodiment of the present disclosure, FIG. 19 is a diagram showing driving waveforms for acquiring sensing voltages from the subpixels shown in FIG. 18 according to an embodiment of the present disclosure, FIG. 20 is a diagram showing a path through which the sensing voltages are acquired from the subpixels shown in FIG. 18 according to an embodiment of the present disclosure, and FIG. 21 is a diagram illustrating the difference between sensing values for the C-th dummy subpixel and the K-th subpixel according to an embodiment of the present disclosure;

FIG. 22 and FIG. 23 are diagrams illustrating the advantages of a sensing voltage acquisition method according to embodiments of the present disclosure, and FIG. 24 is a diagram illustrating a driving environment to which the sensing voltage acquisition method can be applied according to an embodiment of the present disclosure; and

FIG. 25 is a flowchart showing a sensing voltage acquisition method for a first example according to an embodiment of the present disclosure, and FIG. 26 is a flowchart showing a sensing voltage acquisition method for a second example according to an embodiment of the present disclosure.

### DETAILED DESCRIPTION OF THE EMBODIMENTS

A display device according to the present disclosure can be implemented as a television system, an image player, a personal computer (PC), a home theater, an automobile electric device, a smartphone, or the like, but is not limited thereto. The display device according to the present disclosure can be implemented as a light emitting display (LED) device, a quantum dot display (QDD) device, a liquid crystal display (LCD) device, or the like. However, for convenience of description, as an example, a light emitting display device that directly emits light based on inorganic light emitting diodes or organic light emitting diodes will be described below.

The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

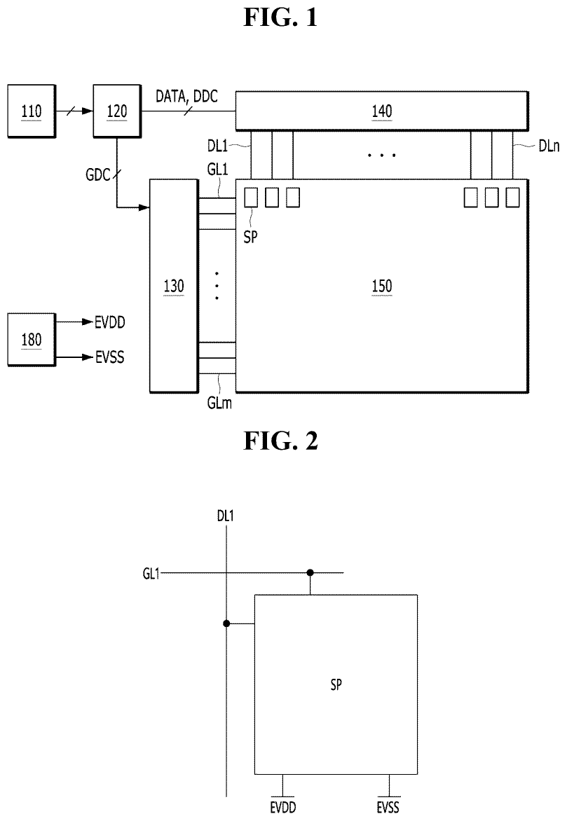

FIG. 1 is a block diagram schematically showing a light emitting display device, FIG. 2 is a configuration diagram schematically showing a subpixel shown in FIG. 1, and FIG. 3 is a diagram showing a pixel composed of subpixels.

As illustrated in FIG. 1, FIG. 2, and FIG. 3, the light emitting display device can include an image provider 110, a timing controller 120, a gate driver 130, a data driver 140, a display panel 150, a power supply 180, and the like.

The image provider 110 (e.g., a set or a host system) can output various driving signals along with an externally supplied image data signal or an image data signal stored in an internal memory. The image provider 110 can supply data signals and various driving signals to the timing controller 120.

The timing controller 120 can output a gate timing control signal GDC for controlling the operation timing of the gate driver 130, a data timing control signal DDC for controlling the operation timing of the data driver 140, and various synchronization signals. The timing controller 120 can supply a data signal DATA supplied from the image provider 110 to the data driver 140 along with the data timing control signal DDC. The timing controller 120 can be implemented in the form of an integrated circuit (IC) and mounted on a printed circuit board, but is not limited thereto.

The gate driver 130 can output a gate signal (or a gate voltage) in response to the gate timing control signal GDC supplied from the timing controller 120. The gate driver 130 can supply gate signals to subpixels included in the display panel 150 through gate lines GL1 to GLm, where m is a real number. The gate driver 130 can be implemented in the form of an IC or directly formed on the display panel 150 in a gate-in-panel structure, but is not limited thereto.

The data driver 140 can sample and latch the data signal DATA in response to the data timing control signal DDC supplied from the timing controller 120, convert the digital data signal into an analog data voltage based on a gamma reference voltage, and output the analog data voltage. The data driver 140 can supply data voltages to the subpixels included in the display panel 150 through data lines DL1 to DLn, where n is a real number. The data driver 140 can be implemented in the form of an integrated circuit (IC) and mounted on the display panel 150 or mounted on a printed circuit board, but is not limited thereto.

The power supply 180 can generate first power at a high level and second power at a low level based on an external input voltage supplied from the outside. The power supply 180 can output the first power through a first power line EVDD and output the second power through a second power line EVSS. The power supply 180 can generate and output voltages (e.g., a scan high voltage and a scan low voltage) to drive the gate driver 130 and voltages (e.g., a drain voltage and a half drain voltage) to drive the data driver 140 as well as the first power and the second power.

The display panel 150 can display an image in response to driving signals including a scan signal and a data voltage, the first power, and the second power. The subpixels of the display panel 150 can directly emit light (e.g., no backlight unit needed). The display panel 150 can be manufactured based on a substrate having rigidity or flexibility, such as glass, silicon, polyimide, or the like. For example, one subpixel SP can be connected to the first data line DL1, the first gate line GL1, the first power line EVDD, and the second power line EVSS and can include a pixel circuit including a switching transistor, a driving transistor, a capacitor, an organic light emitting diode, etc.

Subpixels SP used in the light-emitting display device directly emit light, and thus the circuit configuration thereof may be complicated. In addition, there are various compensation circuits that compensate for deterioration (in the threshold voltage, mobility, etc.) of not only the organic light emitting diode emitting light but also the driving transistor that supplies a driving current to drive the organic light emitting diode. Therefore, the subpixel SP is simply shown in the form of a block.

Subpixels emitting light can be composed of red, green, and blue pixels or red, green, blue, and white pixels. For example, one pixel P can include a red subpixel SPR connected to the first data line DL1, a white subpixel SPW connected to the second data line DL2, a green subpixel SPG connected to the third data line DL3, and a blue subpixel SPB connected to the fourth data line DL4. Additionally, the red subpixel SPR, white subpixel SPW, green subpixel SPG, and blue subpixel SPB can be commonly connected to a first reference line VREF1. The first reference line VREF1 can be used to sense deterioration of elements included in one of the red subpixel SPR, the white subpixel SPW, the green subpixel SPG, and the blue subpixel SPB, which will be described below.

Meanwhile, the timing controller 120, the gate driver 130, and the data driver 140 have been described as individual components. However, depending on the implementation method of the light emitting display device, one or more of the timing controller 120, the gate driver 130, and the data driver 140 can be integrated into a single integrated circuit (IC). In addition, the timing controller 120, the gate driver 130, the data driver 140, the power supply 180, and the display panel 150 are an assembly for displaying images and can be defined as a display module.

In addition, as an example, the pixels P in which the red subpixel SPR, white subpixel SPW, green subpixel SPG, and blue subpixel SPB are arranged in order has been illustrated. However, the arrangement order and direction of subpixels can vary depending on the implementation method of the light emitting display device.

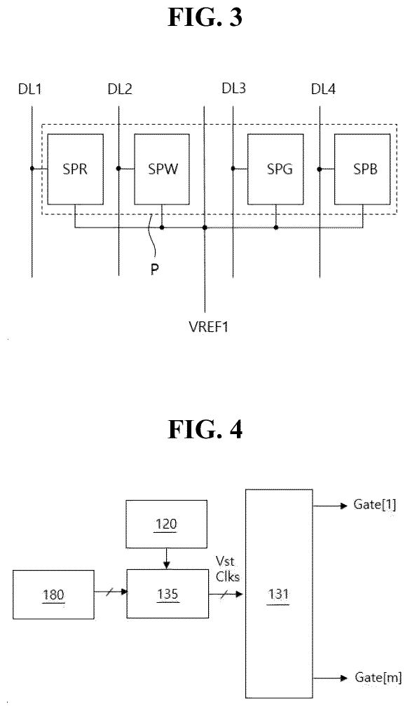

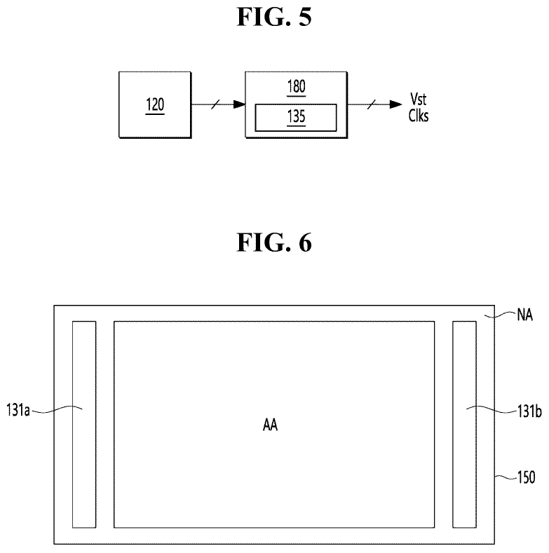

FIG. 4 and FIG. 5 are diagrams illustrating the configuration of a gate-in-panel type gate driver, and FIG. 6 is a diagram showing an example of the arrangement of the gate-in-panel type gate driver.

As shown in FIG. 4, the gate-in-panel type gate driver can include a shift register 131 and a level shifter 135. The level shifter 135 can generate driving clock signals Clks and a start signal Vst based on signals and voltages output from the timing controller 120 and the power supply 180.

The shift register 131 operates based on signals Clks and Vst output from the level shifter 135, and can output gate signals Gate[1] to Gate[m] for turning on or off transistors formed in the display panel. The shift register 131 can take the form of a thin film on the display panel in a gate-in-panel structure.

As shown in FIG. 4 and FIG. 5, unlike the shift register 131, the level shifter 135 can be formed independently in the form of an IC or can be included in the power supply 180. However, this is merely an example and the present disclosure is not limited to thereto.

As shown in FIG. 6, shift registers 131a and 131b that output gate signals in the gate-in-panel type gate driver can be disposed in a non-display area NA of the display panel 150. As an example, the shift registers 131a and 131b are disposed in the left and right non-display areas NA of the display panel 150, but the shift registers 131a and 131b can also be disposed in upper and lower non-display areas NA of the display panel 150 or can be disposed within a display area AA of the display panel 150.

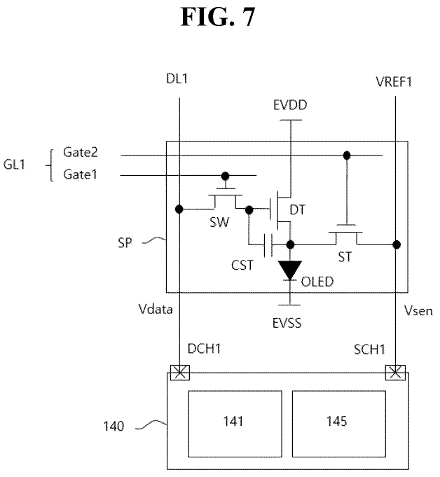

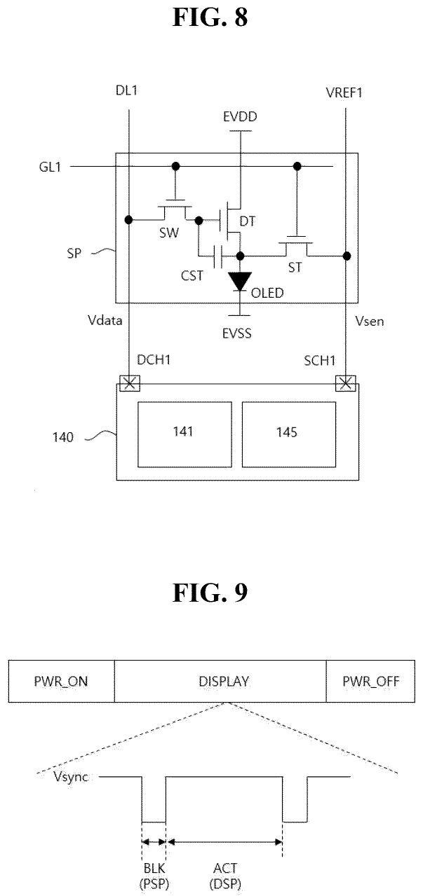

FIG. 7 is a diagram schematically showing a subpixel SP and a data driver 140 according to a first example of an embodiment, FIG. 8 is a diagram schematically showing a subpixel SP and a data driver 140 according to a second example of the embodiment, and FIG. 9 is a waveform diagram illustrating a sensing period and a display period according to an embodiment of the present disclosure.

As shown in FIG. 7, according to the first example, one subpixel SP can include a switching transistor SW, a driving transistor DT, a sensing transistor ST, a capacitor CST, and an organic light emitting diode OLED.

The driving transistor DT can include a gate electrode connected to a first electrode of the capacitor CST, a first electrode connected to the first power line EVDD, and a second electrode connected to the anode of the organic light emitting diode OLED. The capacitor CST can have the first electrode connected to the gate electrode of the driving transistor DT and a second electrode connected to the anode electrode of the organic light emitting diode OLED. The organic light emitting diode OLED can have the anode connected to the second electrode of the driving transistor DT and a cathode connected to the second power line EVSS.

The switching transistor SW can include a gate electrode connected to a first scan line Gate1 included in the first gate line GL1, a first electrode connected to the first data line DL1, and a second electrode connected to the gate electrode of the driving transistor DT. The sensing transistor ST can include a gate electrode connected to a second scan line Gate2 included in the first gate line GL1, a first electrode connected to the first reference line VREF1, and a second electrode connected to the anode of the organic light emitting diode OLED.

The sensing transistor ST is a type of compensation circuit added to compensate for deterioration (e.g., in the threshold voltage, mobility, etc.) of the driving transistor DT or the organic light emitting diode OLED. The sensing transistor ST can enable physical threshold voltage sensing based on the source follower operation of the driving transistor DT. The sensing transistor ST can operate to acquire a sensing voltage through a sensing node defined between the driving transistor DT and the organic light emitting diode OLED.

According to an embodiment, the data driver 140 can include a driving circuit 141 for driving the subpixel SP and a sensing circuit 145 for sensing the subpixel SP. The driving circuit 141 can be connected to the first data line DL1 through a first data channel DCH1. The driving circuit 141 can output a data voltage Vdata for driving the subpixel SP through the first data channel DCH1.

The sensing circuit 145 can be connected to the first reference line VREF1 through a first sensing channel SCH1. The sensing circuit 145 can acquire a sensing voltage Vsen sensed from the subpixel SP through the first sensing channel SCH1. The sensing circuit 145 can acquire the sensing voltage Vsen based on a current sensing or voltage sensing method.

As shown in FIG. 8, according to the second example, the first gate line GL1 can be integrated into one. That is, unlike the first example, the first gate line GL1 may not be divided into the first scan line and the second scan line. In this situation, the switching transistor SW and the sensing transistor ST are both connected to the first gate line GL1 in common, and thus can be turned on or off at the same time.

As shown in FIG. 9, the light emitting display device according to the embodiment can adopt driving modes respectively corresponding to a first driving period PWR_ON (e.g., when powering on the display device), a second driving period DISPLAY, and a third driving period PWR_OFF when operating to drive the display panel (e.g., when powering off the display device).

In more detail, the first driving period PWR_ON can correspond to a driving start period in which power is applied to the display panel, the second driving period DISPLAY can correspond to a panel driving period in which operation such as displaying an image is performed after the power is applied to the display panel, and a third driving period PWR_OFF can correspond to a driving end period in which the power applied to the display panel is cut off. Meanwhile, the third driving period PWR_OFF is a period in which the display panel is driven for a certain period of time while displaying black such that the sensing operation of the display panel can be performed. That is, note that the power applied to the display panel and the like is not completely cut off during the third driving period PWR_OFF. In this way, it can appear to the user that the light emitting display apparatus immediately shuts down in response to an off instruction, but the light emitting display apparatus displays black (displays nothing) but remains on while carrying out the sensing operation before finally shutting down.

The light emitting display device according to the embodiment can sense the display panel in at least one of the first drive period PWR_ON, the second drive period DISPLAY (e.g., during the BLK period), and the third drive period PWR_OFF. As an example, in the second driving period DISPLAY, a blank period BLK included in the vertical synchronization signal Vsync can be defined as a sensing period PSP, and an active period ACT included in the vertical synchronization signal Vsync can be defined as a display period DSP.

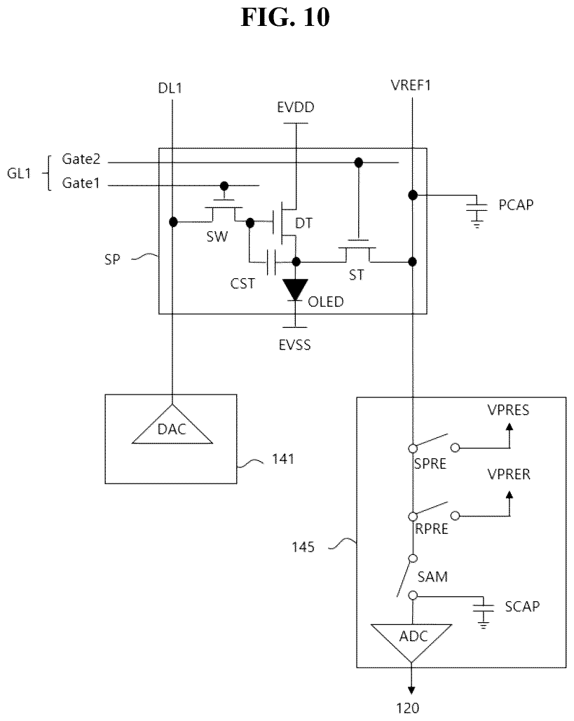

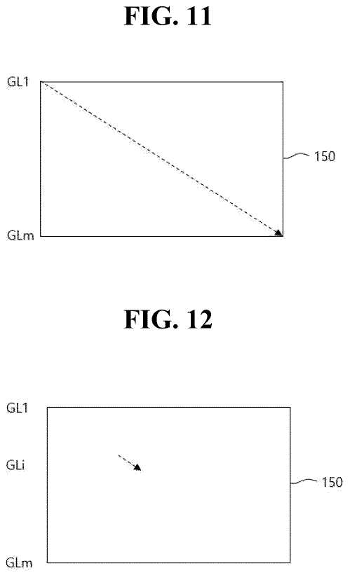

FIG. 10 is a diagram showing some of the components included in the data driver according to an embodiment in more detail, and FIG. 11 and FIG. 12 are diagrams showing a method of sensing the display panel according to embodiments. Hereinafter, as an example, the structure of the subpixel SP shown in FIG. 7 will be described.

As in the embodiment shown in FIG. 10, the driving circuit 141 can include a digital-to-analog converter DAC to output a sensing data voltage, a black data voltage, or a display data voltage through the first data line DL1. The sensing circuit 145 can include a first voltage circuit SPRE, a second voltage circuit RPRE, a sampling circuit SAM, and an analog-to-digital converter ADC to output and sense a voltage through the first reference line VREF1.

The first voltage circuit SPRE and the second voltage circuit RPRE can perform a voltage output operation to initialize nodes or circuits included in the subpixel SP or charge the same to a specific voltage level. The first voltage circuit SPRE and the second voltage circuit RPRE can include a first reference voltage source VPRES and a second reference voltage source VPRER, respectively. The first voltage circuit SPRE can output a first reference voltage based on the first reference voltage source VPRES, and the second voltage circuit RPRE can output a second reference voltage based on the second reference voltage source VPRER. The first reference voltage can be set to a voltage lower than the second reference voltage.

The sampling circuit SAM can perform a sampling operation to acquire a sensing voltage through the first reference line VREF1. For example, the sampling circuit SAM can acquire the sensing voltage from a sensing capacitor PCAP formed on the first reference line VREF1 based on the sensing capacitor PCAP.

The analog-to-digital converter ADC can convert the analog sensing voltage acquired by the sampling circuit SAM into a digital sensing voltage and output the same. For example, the analog-to-digital converter ADC can convert the analog sensing voltage charged in the sensing capacitor PCAP into a digital sensing voltage and output the same.

The timing controller 120 can include a compensator that performs a compensation operation based on a sensing voltage (sensing data value) supplied from the sensing circuit 145. The compensator included in the timing controller 120 can determine whether the driving transistor DT or the organic light emitting diode OLED included in the subpixel SP has deteriorated based on the sensing voltage and compensate for the deterioration.

As shown in FIG. 11, according to the first example, the light emitting display device can perform a sequential sensing method in which sensing is performed from the first gate line GL1 to the M-th gate line GLm of the display panel 150. Although FIG. 11 illustrates an example in which sensing is performed sequentially starting from the first gate line GL1, which is the top of the display panel 150, sensing can start from the M-th gate line GLm, which is the bottom of the display panel 150.

As shown in FIG. 12, according to the second example, the light emitting display device can perform a random sensing method in which only an I-th gate line GLi of the display panel 150 is sensed. Although FIG. 12 illustrates an example in which only the I-th gate line GLi, which is one of specific gate lines, is sensed, the sensing target can be two or more gate lines.

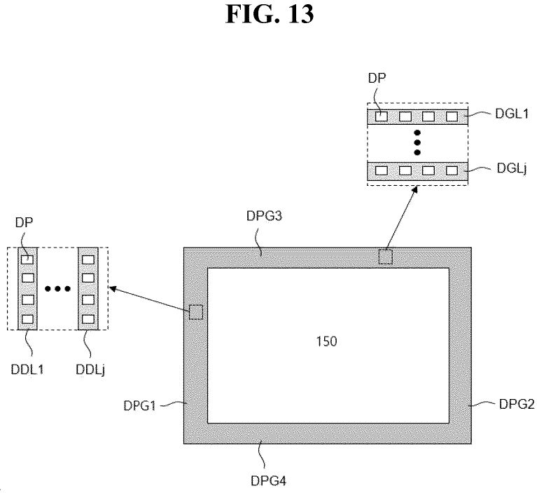

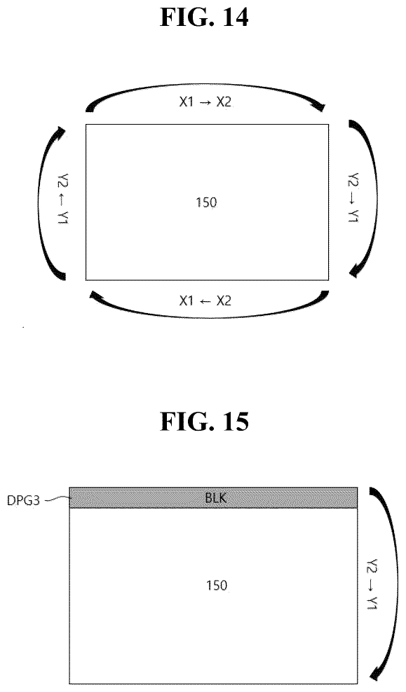

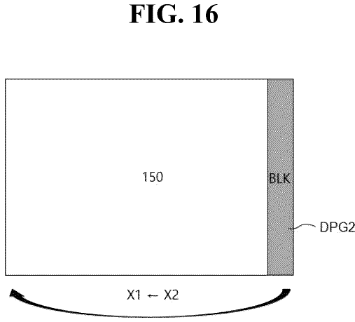

FIG. 13 is a diagram showing dummy pixel groups included in a display panel of a light emitting display device according to an embodiment, and FIG. 14 to FIG. 16 are diagrams illustrating an orbit driving method of the display panel according to an embodiment.

As shown in FIG. 13, the display panel 150 according to the embodiment can include dummy pixel groups DPG1 to DPG4 disposed in an outer area (or bezel area) of the display area. The dummy pixel groups DPG1 to DPG4 can include a first dummy pixel group DPG1, a second dummy pixel group DPG2, a third dummy pixel group DPG3, and a fourth dummy pixel group DPG4.

The first dummy pixel group DPG1 can be located in the left outer area of the display panel 150. The second dummy pixel group DPG2 can be located in the right outer area of the display panel 150. The third dummy pixel group DPG3 can be located in the upper outer area of the display panel 150. The fourth dummy pixel group DPG4 can be located in the lower outer area of the display panel 150.

The first dummy pixel group DPG1 can be connected to a first dummy data line DDL1 to a J-th dummy data line DDLj and can include a plurality of dummy subpixels DP disposed in the vertical direction. Here, j can be an integer of 2 or more. Also, the first dummy pixel group DPG1 can be connected to dummy gate lines to perform the same operation as the subpixels disposed in the display area of the display panel 150. In addition, the second dummy pixel group DPG2 located in the outer area opposite to the first dummy pixel group DPG1 can also have the same structure as the first dummy pixel group DPG1.

The third dummy pixel group DPG3 can be connected to the first dummy gate line DGL1 to the J-th dummy gate line DGLj and can include a plurality of dummy subpixels DP disposed in the horizontal direction. Here, j can be an integer of 2 or more. Also, the third dummy pixel group DPG3 can be connected to dummy data lines to perform the same operation as the subpixels disposed in the display area of the display panel 150. In addition, the fourth dummy pixel group DPG4 located in the outer area opposite to the third dummy pixel group DPG3 can also be disposed in the same form as the third dummy pixel group DPG3.

Meanwhile, note that FIG. 13 briefly shows that a dummy pixel group composed of a plurality of dummy subpixels is disposed in each outer area of the display panel 150 according to the embodiment. In addition, since the dummy pixel groups DPG1 to DPG4 including a plurality of dummy subpixels are not actually driven, they can be implemented by increasing the number of driving transistors significantly compared to the subpixels included in the display area.

As shown in FIG. 14 to FIG. 16, the display panel 150 according to the embodiment can display a specific image (e.g., a screen protection image) rather than a general image. In this situation, the position of the displayed image can be moved in the horizontal direction (X1→X2 or X1←X2), vertical direction (Y2←Y1 or Y2→Y1), or horizontal and vertical directions.

FIG. 15 shows an example in which the position of the display image moves from Y2 to Y1 in the vertical direction of the display panel 150. As shown in FIG. 15, when the position of the display image moves from the top to the bottom, the third dummy pixel group DPG3 located in the upper outer area of the display panel 150 can display a black image BLK. In the opposite situation, the fourth dummy pixel group DPG4 shown in FIG. 13 displays a black image.

FIG. 16 shows an example in which the position of the display image moves from X2 to X1 in the horizontal direction of the display panel 150. As shown in FIG. 16, when the position of the display image moves from right to left, the second dummy pixel group DPG2 located in the right outer area of the display panel 150 can display a black image BLK. In the opposite situation, the first dummy pixel group DPG1 shown in FIG. 13 displays a black image.

When a specific image (hereinafter referred to as a protection image) is displayed as described above, if an orbit driving method is used to move the position where the protection image is displayed, the subpixels included in the display panel 150 continuously display the same image, and thus the deterioration phenomenon can be delayed. Furthermore, if a dummy pixel group disposed in an outer area is displayed in black in addition to moving the position where the protection image is displayed, the problem that the movement of the position of the protection image is visible on the screen can be prevented or the problem of a luminance difference due to the movement of the position of the protection image can be improved.

The light emitting display device according to the embodiment can use dummy pixels (or dummy subpixels) included in the dummy pixel groups DPG1 to DPG4 to shorten a sensing voltage acquisition time. Hereinafter, a sensing voltage acquisition method according to an embodiment in an example of a situation where the position of the protection image displayed on the display panel 150 moves from the top to the bottom, as in the situation of FIG. 15, will be described. In addition, an example in which dummy subpixels are used to shorten a sensing voltage acquisition time will be described below.

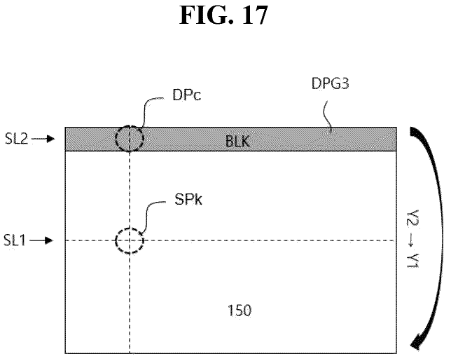

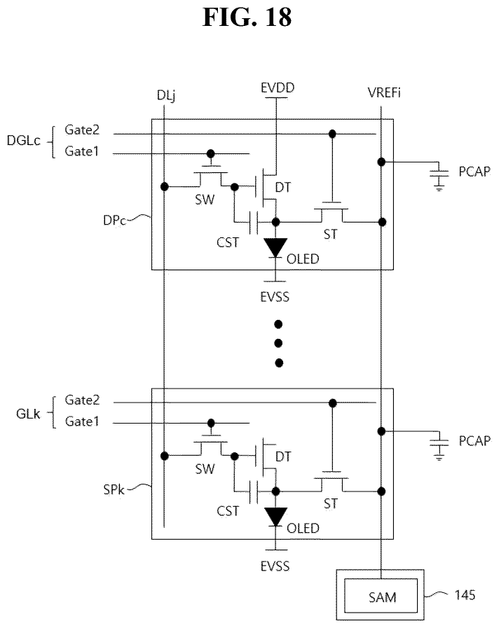

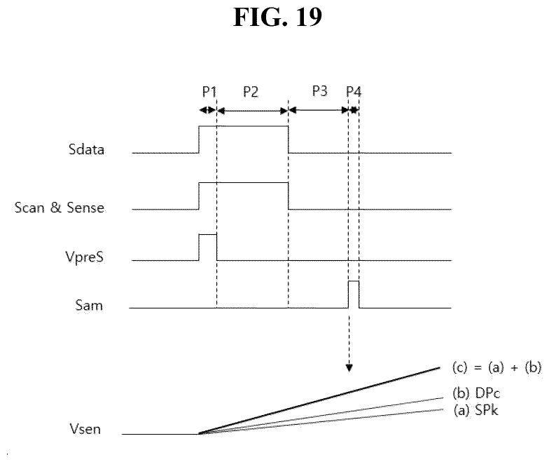

FIG. 17 is a diagram showing the position of a sensing target subpixel of the display panel according to an embodiment, FIG. 18 is an equivalent circuit diagram of a C-th dummy subpixel and a K-th subpixel shown in FIG. 17, FIG. 19 is a diagram showing driving waveforms for acquiring sensing voltages from the subpixels shown in FIG. 18, FIG. 20 is a diagram showing a path through which the sensing voltages are acquired from the subpixels shown in FIG. 18, and FIG. 21 is a diagram illustrating the difference between sensing values for the C-th dummy subpixel and the K-th subpixel.

As shown in FIG. 17, when the position of the protection image moves from the top to the bottom, the third dummy pixel group DPG3 located in the upper outer area of the display panel 150 can display a black image BLK.

In order to shorten the sensing voltage acquisition time, the light emitting display device according to the embodiment can drive and sense at least one first subpixel disposed in the display area of the display panel 150 and at least one first dummy subpixel disposed in the outer area of the display panel 150. On the other hand, a conventional light emitting display device designates a sensing line where a sensing target is located, and drives and senses only one subpixel on the sensing line of the display panel 150.

For example, the light emitting display device according to the embodiment can designate the K-th subpixel SPk of the display area as a first sensing target line SL1, designate the C-th dummy subpixel DPc of the upper outer area as a second sensing target line SL2, and drive and sense the K-th subpixel SPk and C-th dummy subpixel DPc. Here, the K-th subpixel SPk is a specific subpixel in the display area, and the C-th dummy subpixel DPc is a specific dummy subpixel in the outer area. Hereinafter, the embodiment will be described based on the K-th subpixel SPk and the C-th dummy subpixel DPc.

As shown in FIG. 16 and FIG. 18, the C-th dummy subpixel DPc of the upper outer area and the Kth subpixel SPk of the display area can be implemented based on the same elements. The C-th dummy subpixel DPc and the K-th subpixel SPk can be connected to the same J-th data line DLj and the same I-th reference line VREFi. The C-th dummy subpixel DPc can be connected to a C-th dummy gate line DGLc, and the K-th subpixel SPk can be connected to a K-th gate line GLk.

Hereinafter, to describe an example in which the C-th dummy subpixel DPc and the K-th subpixel SPk are driven and sensed simultaneously, a scan signal and a sensing signal applied to the k-th gate line GLk and a scan signal and a sensing signal applied to the C-th dummy gate line DGLc are not distinguished from each other. For example, the k-th gate line GLk and the C-th dummy gate line DGLc can simultaneously receive the same types of scan and sensing signals in synchronization.

As shown in FIG. 19, the light emitting display device according to the embodiment can operate in a first period P1, a second period P2, a third period P3, and a fourth period P4 in order to shorten a sensing voltage acquisition time.

As shown in FIG. 10 and FIG. 17 to FIG. 20, a first reference voltage can be applied to the I-th reference line VREFi of the C-th dummy subpixel DPc and the K-th subpixel SPk during the first period P1. During the first period P1, the first voltage circuit SPRE including the first reference voltage source VPRES can be turned on in response to a first voltage circuit control signal VpreS at a high voltage.

The first voltage circuit control signal VpreS can be applied as a high voltage during the first period P1 and then changed to a low voltage. During the first period P1, the sensing nodes of the driving transistor DT included in the C-th dummy subpixel DPc and the K-th subpixel SPk can be initialized by the first reference voltage.

As shown in FIG. 10 and FIG. 17 to FIG. 20, a sensing data voltage Sdata can be applied to the J-th data line DLj of the C-th dummy subpixel DPc and the K-th subpixel SPk during the second period P2. The driving transistors DT of the C-th dummy gate line DGLc and the K-th gate line GLk can operate as constant current sources for a certain period of time during the second period P2.

During the first period P1 and the second period P2, a first scan signal and a first sensing signal Scan & Sense at a high voltage can be applied to the first scan line Gate1 and the second scan line Gate2 of the C-th dummy gate line DGLc and the K-th gate line GLk. The switching transistors SW and the sensing transistors ST included in the C-th dummy subpixel DPc and the K-th subpixel SPk can be turned on by the high-voltage first scan signal and first sensing signal Scan & Sense. The first scan signal and the first sensing signal (Scan & Sense) can be applied as a high voltage during the first period P1 and the second period P2 and then changed to a low voltage during the third period P3 and the fourth period P4.

A shown in FIG. 10 and FIG. 17 to FIG. 20, during the third period P3, the C-th dummy subpixel DPc and the K-th subpixel SPk are electrically floated, and then a gradual voltage increase can occur at the sensing nodes due to the sensing data voltage Sdata applied to the driving transistors DT.

FIG. 19 illustrates an example in which voltage increase occurs in the C-th dummy subpixel DPc with a higher slope than in the K-th subpixel SPk. This is because voltage change at the sensing node of the driving transistor DT is proportional to the current flowing through the driving transistor DT. Therefore, FIG. 19 can be interpreted as showing that the C-th dummy subpixel DPc and the K-th subpixel SPk can have different voltage increase rates due to different driving conditions (e.g., degrees of deterioration) for the C-th dummy subpixel DPc and the K-th subpixel SPk.

As shown in FIG. 10 and FIG. 17 to FIG. 20, the sampling circuit SAM connected to the I-th reference line VREFi of the C-th dummy subpixel DPc and the K-th subpixel SPk can be turned on in response to a sampling control signal Sam during the fourth period P4.

During the fourth period P4, the sensing circuit 145 can acquire a sensing voltage Vsen applied to the sensing nodes of the C-th dummy subpixel DPc and the K-th subpixel SPk based on the sampling circuit SAM. Here, a first sensing value a applied to the sensing node of the K-th subpixel SPk and a second sensing value b applied to the sensing node of the C-th dummy subpixel DPc are summed together, and thus the sampling circuit SAM can acquire a third sensing value c corresponding to a+b as the sensing voltage Vsen (e.g., a+b=c).

The light emitting display device according to the embodiment can detect the characteristics (e.g., values by which presence or absence of deterioration can be determined) of the driving transistors DT included in the C-th dummy subpixel DPc and the K-th subpixel SPk and update compensation values. The aforementioned second sensing value b applied to the sensing node of the C-th dummy subpixel DPc can correspond to a dummy value used to shorten the sensing voltage acquisition time. Therefore, since the C-th dummy subpixel DPc is used to serve as a constant current source that increases the current at the time of sensing the K-th subpixel SPk, the second sensing value b corresponding to the dummy value obtained from the C-th dummy subpixel DPc can be removed (offset) by an algorithm in the timing controller.

Meanwhile, the K-th subpixel SPk displays an image with a certain luminance in the display area and thus is exposed to deterioration, whereas the C-th dummy subpixel DPc displays a black image (or displays no image) in the outer area and thus is not exposed to deterioration compared to the K-th subpixel SPk. Therefore, as shown in FIG. 21, the first sensing value a applied to the sensing node of the K-th subpixel SPk can be variable, but the second sensing value b applied to the sensing node of the C-th dummy subpixel DPc can be constant.

For example, the dummy subpixels along the outer boarder of the display area can be saved or reserved (e.g., protected) so that the dummy subpixels can be used as a constant reference for evaluating the deterioration of the regularly driven subpixels. Also, since the dummy subpixel and the regular subpixel are sensed together at the same time, this can speed up or shorten the sensing time because a reliable measurement can be obtained at an earlier time point. In other words, the component due to the sensing of the dummy subpixel can act as a reliable bias that can be added to the sensing of a regular subpixel to shorten the measurement time, and the bias can be later removed (offset) since it can be known and constant.

In other words, it can be assumed that the second sensing value b applied to the sensing node of the C-th dummy subpixel (DPc) is constant. The timing controller can implement a modeling expression based on the above logic and remove (offset) the second sensing value b corresponding to the dummy value based on the modeling expression.

The timing controller can calculate a compensation value for compensating for deterioration of the driving transistor DT included in the K-th subpixel SPk based on the sensing voltage obtained from the K-th subpixel SPk. Additionally, the timing controller can calculate a compensation value for compensating for the subpixels disposed in the display area of the display panel 150 by using the sensing voltage obtained from the K-th subpixel SPk as a representative value. In addition, the timing controller can calculate a compensation value in association with temperature change (temperature distribution) in the display panel 150.

An example in which the C-th dummy subpixel DPc and the K-th subpixel SPk are connected to the same data line and the same reference line has been illustrated and described above. However, the C-th dummy subpixel DPc and the K-th subpixel SPk can be connected to different data lines and reference lines, and sensing voltages obtained from the C-th dummy subpixel DPc and the K-th subpixel SPk can be summed in the sensing circuit 145.

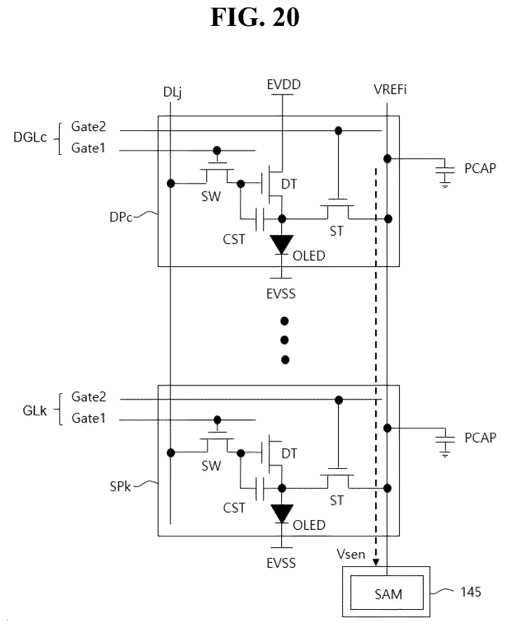

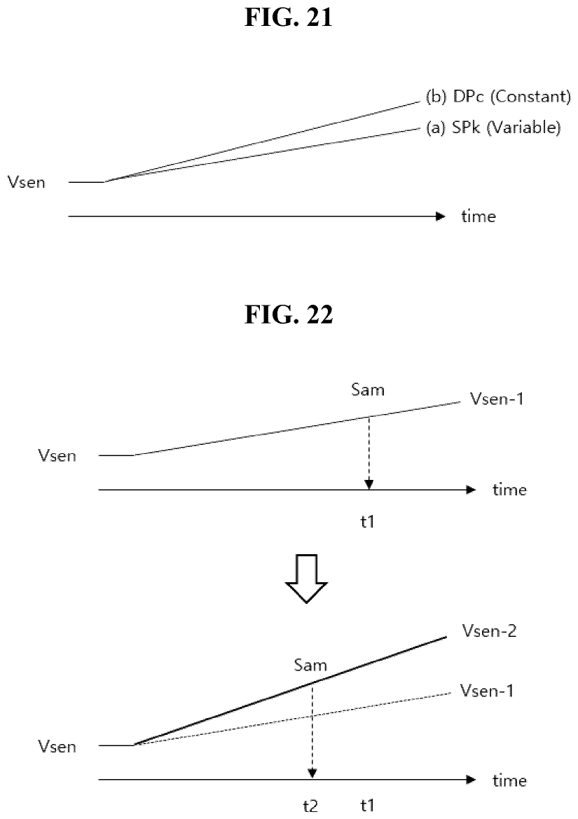

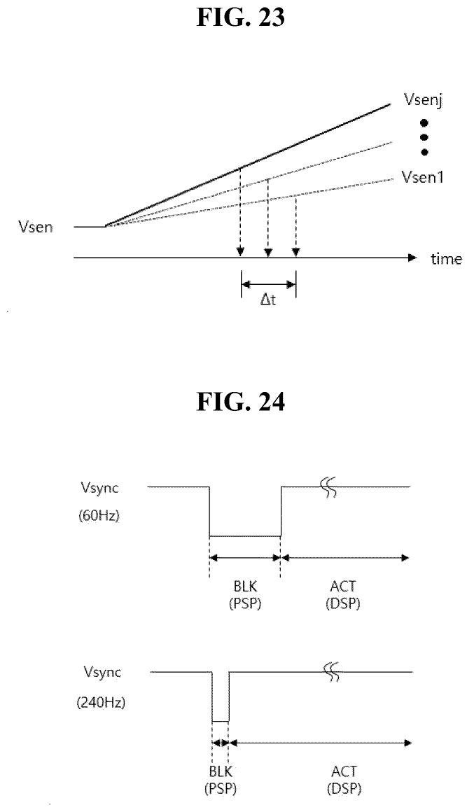

FIG. 22 and FIG. 23 are diagrams illustrating the advantages of a sensing voltage acquisition method according to an embodiment, and FIG. 24 is a diagram illustrating a driving environment to which the sensing voltage acquisition method according to the embodiment can be applied.

As shown in FIG. 22, in a conventional sensing voltage acquisition method, only one subpixel is driven and sensed, and thus a sensing voltage Vsen-1 can be acquired according to a sampling control signal Sam generated at a first time t1. On the other hand, a subpixel used for image display and a dummy subpixel that is not used for image display are driven and sensed together in the embodiment, and thus a sensing voltage Vsen-2 can be acquired according to a sampling control signal Sam generated at a second time t2, which is earlier than the first time t1. That is, the sensing voltage acquisition method according to the embodiment can shorten the sensing voltage acquisition time compared to the conventional sensing voltage acquisition method. For example, the sensing of the dummy subpixel can act as a reliable bias to speed up the sensing voltage acquisition time,

As shown in FIG. 23, the sensing voltage acquisition method according to the embodiment can drive and sense a plurality of dummy subpixels or a plurality of pixels that are not used for image display. Therefore, the sensing voltage acquisition method according to the embodiment can shorten the time required to acquire a sensing voltage Vsen by At corresponding to the number of dummy sensing targets Vsen1 to Vsenj.

As shown in FIG. 24, the sensing voltage acquisition method according to the embodiment can be performed during a blank period BLK included in a vertical synchronization signal Vsync. That is, the blank period BLK can be shortened or lengthened depending on factors that determine a driving frequency, such as the vertical synchronization signal Vsync.

For example, the blank period BLK of the vertical synchronization signal Vsync generated based on a driving frequency of 60 Hz is longer than the blank period BLK of the vertical synchronization signal Vsync generated based on a driving frequency of 240 Hz. In other words, when the driving frequency of the light emitting display device is 240 Hz, the time to acquire a sensing voltage is shorter than that when the driving frequency is 60 Hz. Therefore, the sensing voltage acquisition method according to the embodiment can be advantageous when applied to a light emitting display device with a high driving frequency (e.g., a high-resolution, high-frequency, high-PPI model). In other words, by adding the bias provided by sensing both of a dummy subpixel and a regular subpixel together, then a reliable measurement can be obtained much quicker can be carried out during a shorter blank period BLK (e.g., BLK when driven at 240 Hz).

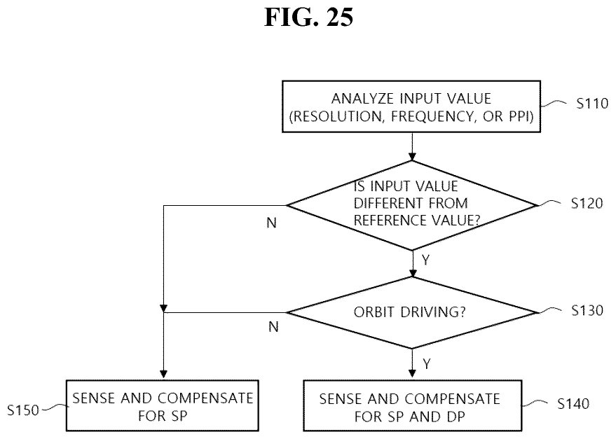

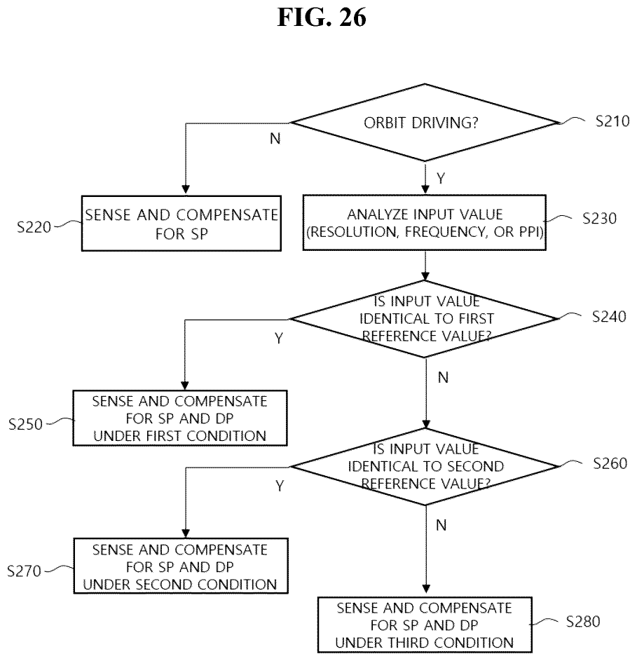

FIG. 25 is a flowchart showing a sensing voltage acquisition method according to a first example, and FIG. 26 is a flowchart showing a sensing voltage acquisition method according to a second example.

As shown in FIG. 25, according to the first example, an input value (e.g. resolution or frequency) is analyzed (S110), it is determined whether the input value is different from a reference value (S120), and sensing is mainly performed on the subpixels SP disposed in the display area and compensation is performed if the input value is the same as the reference value (N) (S150).

On the other hand, if the input value is different from the reference value (Y), it is determined whether orbit driving is being performed (S130), and if orbit driving is being performed (Y), the subpixels SP disposed in the display area and dummy subpixels DP disposed in the outer area are sensed together and compensation is performed (S140). On the other hand, if orbit driving is not performed (N), sensing is mainly performed on the subpixels SP disposed in the display area and compensation is performed (S150).

As can be ascertained in the example of FIG. 25, the sensing voltage acquisition method (e.g., combining sensing of a dummy subpixel and a regular subpixel together) according to the embodiment can be performed when one of the resolution and frequency is high and during orbit driving.

As shown in FIG. 26, according to the second example, it is determined whether orbit driving is being performed (S210), and if orbit driving is not performed (N), sensing is mainly performed on the subpixels SP disposed in the display area and compensation is performed (S220).

On the other hand, if orbit driving is being performed (Y), an input value (e.g., resolution or frequency) is analyzed (S110), it is determined whether the input value is equal to a first reference value (S240), and if the input value is equal to the first reference value (Y), subpixels SP disposed in the display area and dummy subpixels DP displayed in the outer area are sensed together and compensation is performed under a first condition (S250).

If the input value is not equal to the first reference value (N), it is determined whether the input value is equal to a second reference value (S260), and if the input value is equal to the second reference value (Y), the subpixels SP disposed in the display area and the dummy subpixels DP disposed in the outer area are sensed together and compensation is performed under a second condition (S270).

If the input value is not equal to the second reference value (N), the subpixels SP disposed in the display area and the dummy subpixels DP disposed in the outer area are sensed together and compensation is performed under a third condition (S280).

As can be ascertained in the example of FIG. 26, the sensing voltage acquisition method according to the embodiment can configure a number of conditional expressions in consideration of the diversity of resolution and frequency, and vary the number of dummy subpixels DP or the number of dummy pixels included in the conditions depending on the resolution and frequency.

As described above, the present disclosure has the effects of reducing a time required to acquire a sensing voltage such that deterioration of elements included in a display panel can be sensed and compensated for even in high-resolution, high-frequency, and high-PPI models and securing a time necessary for precise compensation based on minimization of a sensing time to improve compensation performance.

It will be apparent to those skilled in the art that various modifications and variations can be made in the present disclosure without departing from the spirit or scope of the present disclosure. Thus, it is intended that the present disclosure cover the modifications and variations of the present disclosure provided they come within the scope of the appended claims and their equivalents.

What is claimed is:

1. A display device comprising:
a display panel including subpixels disposed in a display area and dummy subpixels disposed in an outer area of the display panel;
a driving circuit configured to output a sensing data voltage for sensing a first subpixel among the subpixels and a first dummy subpixel among the dummy subpixels; and
a sensing circuit configured to:
receive a first sensing value from a sensing node of the first subpixel and a second sensing value from a sensing node of the first dummy subpixel, and
generate a sensing voltage based on a sum of the first sensing value and the second sensing value.

2. The display device of claim 1, wherein the second sensing value corresponding to the first dummy subpixel acts as a constant current source for increasing current when sensing the first sensing value corresponding to the sensing node of the first subpixel.

3. The display device of claim 1, further comprising:
a compensator configured to generate a compensation value for compensating the first subpixel based on the first sensing value and excluding or offsetting the second sensing value.

4. The display device of claim 1, wherein the sensing circuit is further configured to:
acquire a sensing value from one of the dummy subpixels or acquire sensing values from a plurality of dummy subpixels based on at least one of a resolution of the display panel, a driving frequency of the display panel, or pixel per inch of the display panel.

5. The display device of claim 1, wherein the dummy subpixels display a black image when a position where a protection image displayed based on the subpixels is displayed is moved.

6. A display device comprising:
a display panel including subpixels disposed in a display area and dummy subpixels disposed in an outer area outside of the display panel;
a driving circuit configured to:
display a protection image based on the subpixels,
move a position where the protection image is displayed, and
move a position of a black image displayed on at least one of the dummy subpixels when the display position of the protection image is moved; and
a sensing circuit configured to:
acquire a first sensing value from a first subpixel among the subpixels and a second sensing value from a first dummy subpixel displaying the black image among the dummy subpixels, and
acquire a sensing voltage based on a sum of the first sensing value and the second sensing value.

7. The display device of claim 6, further comprising:
a compensator configured to generate a compensation value for compensating the first subpixel based on the first sensing value and excluding or offsetting the second sensing value from the sensing voltage.

8. The display device of claim 6, wherein the sensing circuit is further configured to:
acquire a sensing value from one of the dummy subpixels or acquire sensing values from a plurality of dummy subpixels based on at least one of a resolution of the display panel, a driving frequency of the display panel, or pixel per inch of the display panel.

9. A method of driving a display device, comprising:
displaying a protection image based on subpixels disposed in a display area of a display panel in the display device and moving a position where the protection image is displayed;
displaying a black image on at least one of dummy subpixels disposed in an outer area of the display panel and moving a position of the black image when the display position of the protection image is moved;
acquiring a first sensing value from a first subpixel among the subpixels and a second sensing value from a first dummy subpixel displaying the black image among the dummy subpixels;
acquiring a sensing voltage based on a sum of the first sensing value and the second sensing value; and
generating a compensation value for compensating the first subpixel based on the first sensing value and excluding or offsetting the second sensing value from the sensing voltage.

10. The method of claim 9, wherein the acquiring of the sensing voltage includes acquiring a sensing value from one of the dummy subpixels or acquiring sensing values from a plurality of dummy subpixels based on at least one of a resolution of the display panel, a driving frequency of the display panel, or pixel per inch of the display panel.

11. A display device comprising:
a display panel including subpixels disposed in a display area and dummy subpixels disposed in an outer area of the display panel; and
a controller configured to:
display a protection image at a first position on the display panel,
display the protection image at a second position on the display panel, the second position being different than the first position,
in response to the protection image moving from the first position to the second position, display a black image by at least one dummy subpixel among the dummy subpixels that corresponds to a portion of the protection image previously displayed at the first position,
receive a first sensing value from a first subpixel among the subpixels and a second sensing value from the at least one dummy subpixel, and
generate a sensing voltage corresponding to the first subpixel based on a sum of the first sensing value and the second sensing value.

12. The display device of claim 11, wherein the first sensing value from the first subpixel and the second sensing value from the at least one dummy subpixel are obtained at a same time and based on a same first reference voltage.

13. The display device of claim 11, wherein the controller is further configured to:
supply a compensation voltage to the first subpixel based on the sensing voltage being offset or excluding the second sensing value from the at least one dummy subpixel.

14. The display device of claim 11, wherein the controller is further configured to:
display the protecting image based on orbit driving.

15. The display device of claim 11, wherein the controller is further configured to:
in response to the display panel being driven at a first driving frequency, perform a sensing operation for at least one of the subpixels without sensing any of the dummy subpixels, and
in response to the display panel being driven at a second driving frequency higher than the first driving frequency, perform a sensing operation for the at least one of the subpixels based on a sum of a sensing value for the at least one of the subpixels and a sensing value for at least one of the dummy subpixels.

16. The display device of claim 11, wherein the first subpixel and the at least one dummy subpixel have a same circuit configuration.

17. The display device of claim 11, wherein the controller is further configured to:
perform sensing of the first sensing value from the first subpixel and sensing the second sensing value from the at least one dummy subpixel during a blank period of a vertical synchronization signal.

18. The display device of claim 11, wherein the first subpixel and the at least one dummy subpixel are connected to a same data line.

19. The display device of claim 11, wherein the second sensing value corresponding to the at least one first dummy subpixel increases current when sensing the first sensing value corresponding to the first subpixel.

20. The display device of claim 11, wherein the second sensing value corresponding to the at least one first dummy subpixel is a bias voltage.
